(19) United States
(12) Patent Application Publication
(10) Pub. No.: US 2017/0220581 A1
(43) Pub. Date: Aug. 3, 2017

(54) Content Item and Source Detection System

(71) Applicant: Microsoft Technology Licensing, LLC., Redmond, WA (US)

(72) Inventors: Alex D. Wade, Seattle, WA (US); Darrin Eugene Eide, Bellevue, WA (US); Qian Zhang, Bellevue, WA (US); Annie Yang Bai, Redmond, WA (US); Tomi Paananen, Tampere (FI); Juhana Koski, Tampere (FI); Mithun Ashok, Bangalore (IN); Allison Anne Whilden, Kirkland, WA (US); Ruth Kikin-Gil, Bellevue, WA (US); Shikha Devesh Desai, Bellevue, WA (US); Yu Been Lee, Bellevue, WA (US); Paul Anthony Scudieri, Seattle, WA (US); Kalpesh S. Bhimani, Bothell, WA (US); Kevin Thomas Coughlin, Seattle, WA (US); Derek Hang, Seattle, WA (US); David Liu, Issaquah, WA (US)

(73) Assignee: Microsoft Technology Licensing, LLC., Redmond, WA (US)

(21) Appl. No.: 15/181,355

(22) Filed: Jun. 13, 2016

(30) Foreign Application Priority Data
Feb. 2, 2016 (IN) 201641003644

(51) Int. Cl. G06F 17/30; G10L 15/26; G06K 9/34; G06Q 20/10

(52) U.S. Cl. CPC G06F 17/3053; G06F 17/30554; G06F 17/30598; G06F 17/30011; G06F 17/30867; G06Q 20/102; G10L 15/26; G06K 9/344

(57) ABSTRACT

To improve efficiency of computing devices and improve the user experience thereon when searching for content items, the systems and methods disclosed herein provide content item and source detection. Non-textual input is converted to a searchable format and corresponding content items are searched for based on the searchable format.

### CROSS-REFERENCE TO RELATED APPLICATIONS

This application claims the benefit of India Provisional Patent Application No. 201641003644, titled “CONTENT ITEM AND SOURCE DETECTION SYSTEM,” which was filed Feb. 2, 2016.

### BACKGROUND

Content items are often presented through a variety of media. However, many types of content items, such as print, presentation or other tangible media, often require computer users to search for sources of digital versions of the content items or related content items.

As is often the case, a person may receive a handout of a content item in printed form. After reviewing a portion of the content item, the person may wish to save the content item, review content items cited in the content item, view the references listed in the content item, or view related content items. Unfortunately, the person is presented with two options, namely going to a library to attempt to retrieve printed copies of the content items or to perform Internet searches for digital copies of the content items. Either type of searching is inefficient and time consuming.

However, performing searches for the title and/or author of the content items may produce an exorbitant amount of results. For example, an Internet search for a particular title or author may result hundreds of results with similar titles or other content items by the same author. The person is then required to skim through each of the search results and read abstracts or summaries of the content items to determine whether the content items may be of interest. Unfortunately, the search results, which appeared to be responsive to the search, may not actually locate the particular content item of interest. Alternatively, even if particular content item is located in the search results, the person may later decide that the particular content item is not useful or relevant. Thus, the person's time may be wasted on searching, skimming through the search results, and reading abstracts or summaries.

Even when interesting content items are located, the person must then keep track of all of the content items. For tangible content items, a person may be required to scan a copy of the content item or the person may be required to manually type the content item into a software application. For digital content items, the person may send himself/herself links to the content items or store links to the content items within the software application. However, these manual processes are laborious and require the person to spend even more time documenting the content items.

It is with respect to these and other considerations that the present disclosure has been made. Although relatively specific problems have been discussed, it should be understood that the examples disclosed herein should not be limited to solving the specific problems identified in the background.

### SUMMARY

This summary is provided to introduce a selection of concepts in a simplified form that are further described below in the Detailed Description section. This summary is not intended to identify all key or essential features of the claimed subject matter, nor is it intended as an aid in determining the scope of the claimed subject matter.

To improve efficiency of computing devices and improve the user experience thereon when searching for content items, the systems and methods disclosed herein provide content item and source detection. Non-textual input is converted to a searchable format and corresponding content items are searched for based on the searchable format. The conversion of non-textual data to a searchable format of data may use known formats of papers, including imaged text that is sized differently than body text, to identify key words and phrases to search for the content item.

Examples are implemented as a computer process, a computing system, or as an article of manufacture such as a device, computer program product, or computer readable medium. According to an aspect, the computer program product is a computer storage medium readable by a computer system and encoding a computer program comprising instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 is a block diagram of an example content item and source detection system;

FIG. 2 is graphical representation of a flow of data in an example method for detection and retrieval of content items and source information;

FIG. 3 is an illustration showing an example web interface for a content item and source detection system on a computing device;

FIG. 4 is an illustration showing an application user interface for image capture in an example content item and source detection system on a computing device;

FIG. 5 is an illustration showing an application user interface for displaying a content item in an example content item and source detection system on a computing device;

FIG. 6 is an illustration showing an application user interface for displaying a summary of a content item in an example content item and source detection system on a computing device;

FIG. 7 is an illustration showing an interaction with an application user interface for displaying references cited in a content item in an example content item and source detection system on a computing device;

FIG. 8 is an illustration showing an interaction with an application user interface for displaying additional information relating to a reference in an example content item and source detection system on a computing device;

FIG. 9 is an illustration showing an interaction with an application user interface for selecting references in an example content item and source detection system on a computing device;

FIG. 10 is an illustration showing an interaction with an application user interface for sharing content items in an example content item and source detection system on a computing device;

FIG. 11 is an illustration showing an application user interface to provide options for sharing content items in an example content item and source detection system on a computing device;

FIG. 12 is an illustration showing an interaction with an application user interface for displaying account information in an example content item and source detection system on a computing device;

FIG. 13 is an illustration showing an interaction with an application user interface for locating content items available for purchase in an example content item and source detection system on a computing device;

FIG. 14 is an illustration showing an interaction with an application user interface in an example content item and source detection system on a computing device;

FIG. 15 is an illustration showing an application user interface in an example content item and source detection system on a computing device;

FIG. 16 is an illustration showing an interaction with an application user interface in an example content item and source detection system on a computing device;

FIG. 17 is an illustration showing an application user interface for displaying additional content items in an example content item and source detection system on a computing device;

FIG. 18 is a flow chart showing general stages involved in an example method for detection of content items and source information;

FIG. 19 is a block diagram of an example content item and source detection system;

FIG. 20 is a block diagram illustrating example physical components of a computing device;

FIGS. 21A and 21B are block diagrams of a mobile computing device; and

FIG. 22 is a block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

Aspects of the content item and source detection system are described herein and are illustrated in the accompanying figures. Aspects of the disclosure are described in terms of a traditional user interface layout merely to provide a standard frame of reference; however, the disclosure is not limited to traditional user interface layouts. As such, usage of a particular orientation (e.g., horizontal, vertical, landscape, portrait, etc.), direction (e.g., left, right, up, down), position (e.g., top, bottom, side, above, below, front, back, etc.), and dimension (e.g., height, width, etc.) should not be construed as limiting to that particular orientation, direction, position, or dimension.

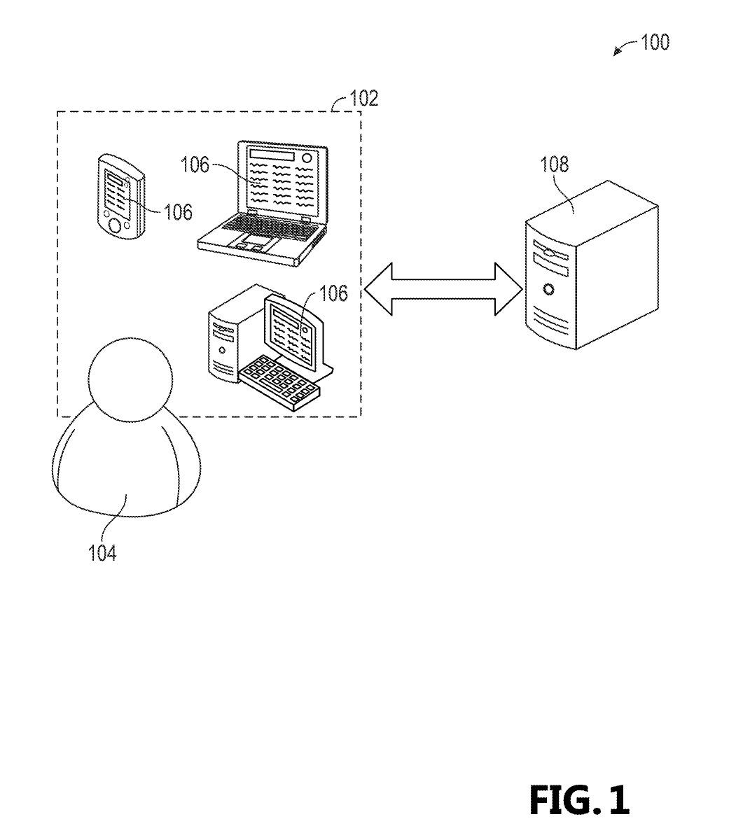

Aspects of the present disclosure are directed to a method, system, and computer storage medium for detection and retrieval of content items and source information. FIG. 1 is a block diagram of an example content item and source detection system 100. The example content item and source detection system 100 includes a computing device 102, utilized by a user 104, in the form of a desktop computer, laptop computer, tablet computer, handheld computing device, mobile communication device, wearable device, gaming device, and the like. Further, the content item and source detection system 100 includes at least one application 106 executing on the computing device 102. In one example, the application 106 is provided via a website available on the Internet. The application 106 may also be one of various types of applications or a suite of applications, such as, but not limited to, a mobile application, an electronic mail and contacts application, a word processing application, a spreadsheet application, a database application, a slide presentation application, an information management application, an Internet browser application, etc.

Further, the application 106 is operable to receive input data including at least a portion of a content item. The application 106 is also configured to communicate with another computing device 108 to locate and facilitate in the identification, retrieval, and/or storage of the content item. The other computing device 108 may be in the form of a cloud-based service provided by a server, a network server, a desktop computer, a laptop computer, a tablet computer, a handheld computing device, a mobile communication device, and the like.

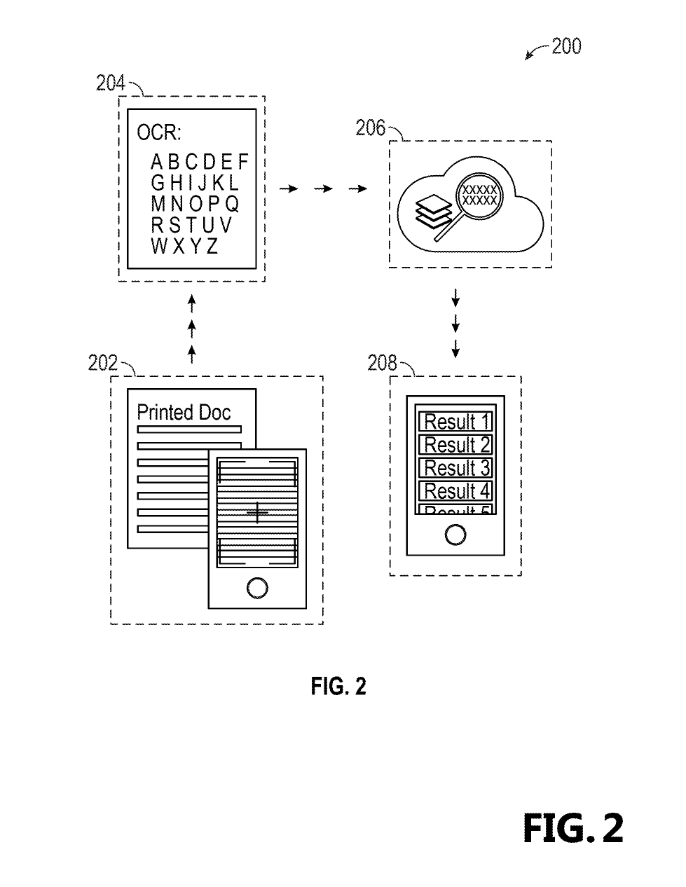

FIG. 2 is a graphical representation of a flow of data 200 in an example method for the detection of content items and source information. As illustrated, the example flow of data begins at 202 with the computing device receiving an input associated with a content item. In the illustrated example, a mobile computing device captures an image of a content item, e.g., a page of a printed document. In another example, the content item may be received via speech input. In other examples, the computing device may receive the content item through another type of input.

After the computing device have received the input associated with the content item, the example flow of data continues to 204, where the input is analyzed to identify searchable data that relates to the input. For example, the illustrated example shows that the captured image is processed via optical character recognition to obtain textual data. In other examples, the input may be analyzed to identify pictures or other types of data that may be searched.

After searchable data has been identified from the input, the example flow of data continues to 206, where a search for relevant content items is performed. The illustrated example shows that a search is being performed for the textual data found in the input. The search may be performed based on a portion of the identified searchable data or all of the identified searchable data.

Once the search is completed, the example flow of data continues to 208, where the content items located during the search are then returned as candidate content items. In the illustrated example, the computing device displays candidate content items in results 1-4. It should also be appreciated that the candidate content items may otherwise be displayed.

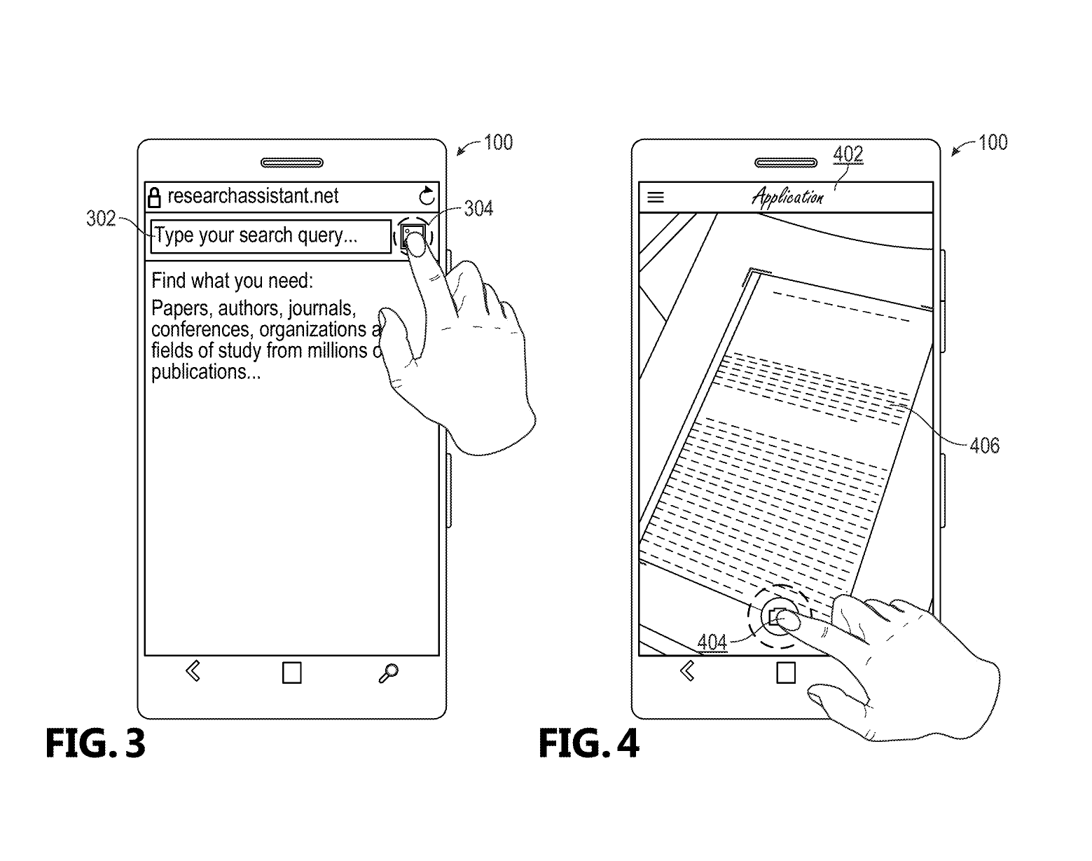

FIG. 3 is an illustration showing an example web interface for a content item and source detection system 100 on a computing device. In the illustrated example, a mobile device is displaying an application for performing search queries. The user interface includes a textual base input 302 to perform traditional search queries. The illustrated user interface also includes a user interface element 304 to receive non-textual input for a search query. As illustrated, the mobile device user may utilize touch input to select the user interface element 304 to activate a camera for performing an imaged based search. It should also be recognized, in other computing devices that the user interface element may be selected by mouse input, gesture input, or speech input.

FIG. 4 is an illustration showing an application user interface 402 for image capture in an example content item and source detection system 100 on a computing device. In the illustrated example, the application user interface 402 on a mobile device is displaying an example of receiving non-textual input. Specifically, the illustrated example shows a user utilizing the camera feature 404 on the mobile device to capture an image of a printed document 406.

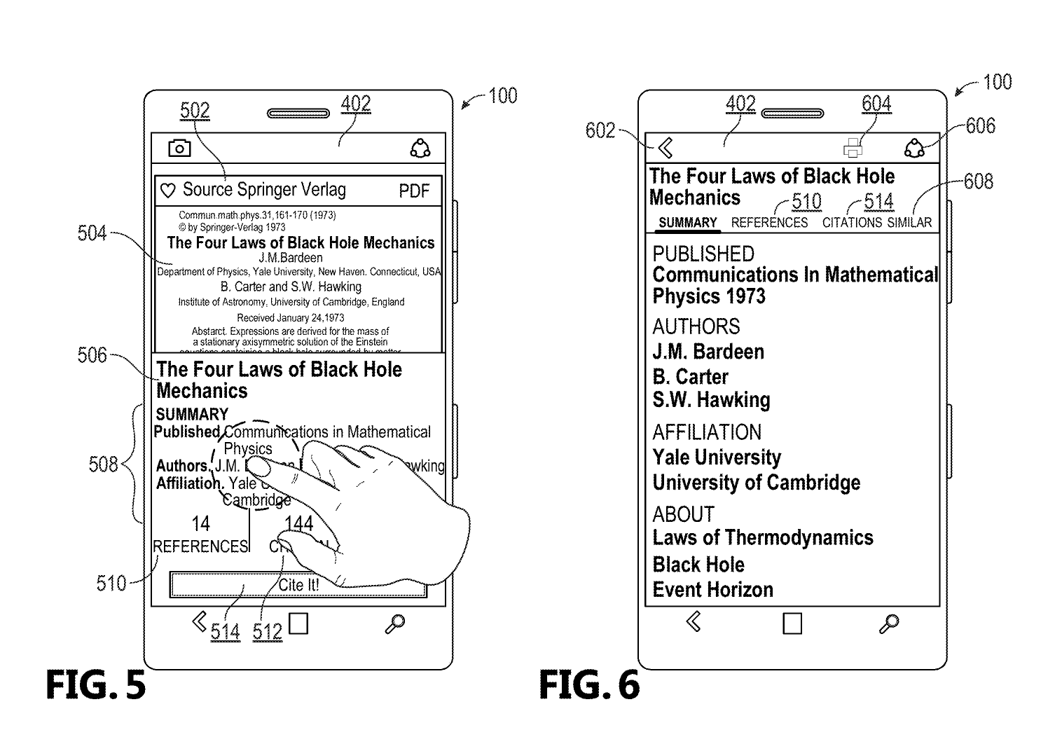

FIG. 5 is an illustration showing an application user interface 402 for displaying a content item in an example content item and source detection system 100 on a computing device. In the illustrated example, a mobile device is displaying an example overview of a content item responsive to the non-textual input. The application user interface 402 includes a source name 502, a preview 504 of the content item, a title 506, summary information 508, and other additional information including references 510 cited in the content item, citations 512 of the content item, and information identifying other similar content items. According to one aspect, the information displayed on the application user interface 402 is provided based on the search results and may include use of an academic research database API (Application Program Interface) to retrieve additional information, e.g., publication details, citations, similar content, etc., that relate to the search results. Additionally, the illustrated example includes information identifying the number of references 510 cited in the content item, the number of citations 512 of the content item, and the number of other similar content items. The other similar content items provide the user with the ability to browse new content that is relevant to the search content item. The ability to access similar content items, which may differ slightly from the searched topic, further contributes to the efficiency of the system to provide the user with the ability to locate other content without having to perform additional searches. The application user interface 402 may also include user interface elements that provide a citation 514 of the relevant content item. Further, as shown in the illustrated example, a user may select the user interface elements to display the selected information. As shown in the illustrated example, a user has selected the summary information 508 for the content item.

FIG. 6 is an illustration showing an application user interface 402 for displaying a summary view of a content item in an example content item and source detection system 100 on a computing device. In the illustrated example, the application user interface 402 is updated to display a summary view of the content item selected in FIG. 5. The application user interface 402 also includes a user interface element 602 for returning to the overview of the content item, a user interface element 604 for printing, and a user interface element 606 for sharing or exporting the content item. The application user interface 402 may also include links to references 510 cited in the content item, citations 514 of the content item, and information identifying other similar 608 content items.

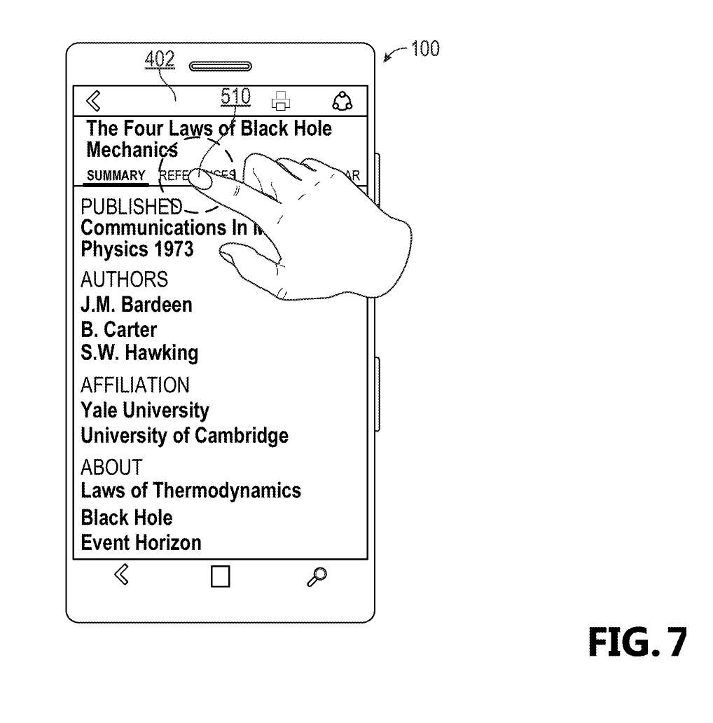

FIG. 7 is an illustration showing an interaction with an application user interface 402 for displaying references cited in a content item in an example content item and source detection system 100 on a computing device. In the illustrated example, in response to the user selecting the reference link 510, the application user interface 402 is updated to display one or more references cited in the content item. As illustrated, the references may include information such as a title, publication information, author, and abstract information.

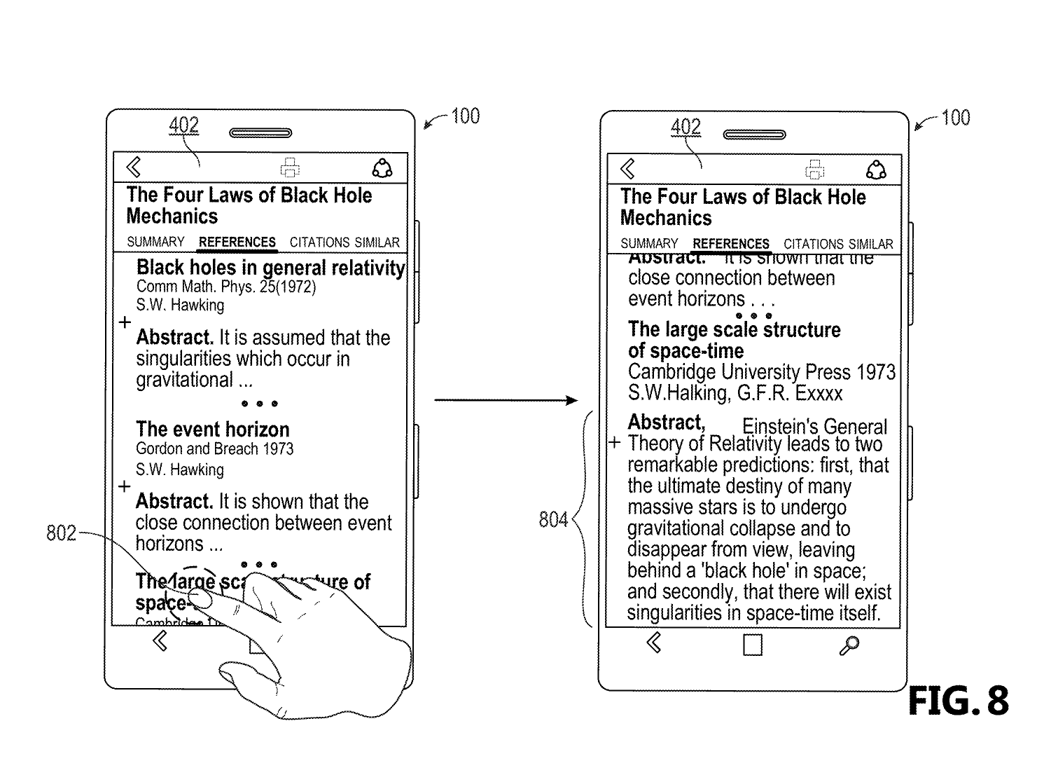

FIG. 8 is an illustration showing an interaction with an application user interface 402 for displaying additional information relating to a reference in an example content item and source detection system 100 on a computing device. The illustrated example depicts a selection 802 of one of the abstracts relating to a reference cited in the content item. In response to the selection 802, the application user interface 402 is updated to display the entire abstract 804 provided by the reference.

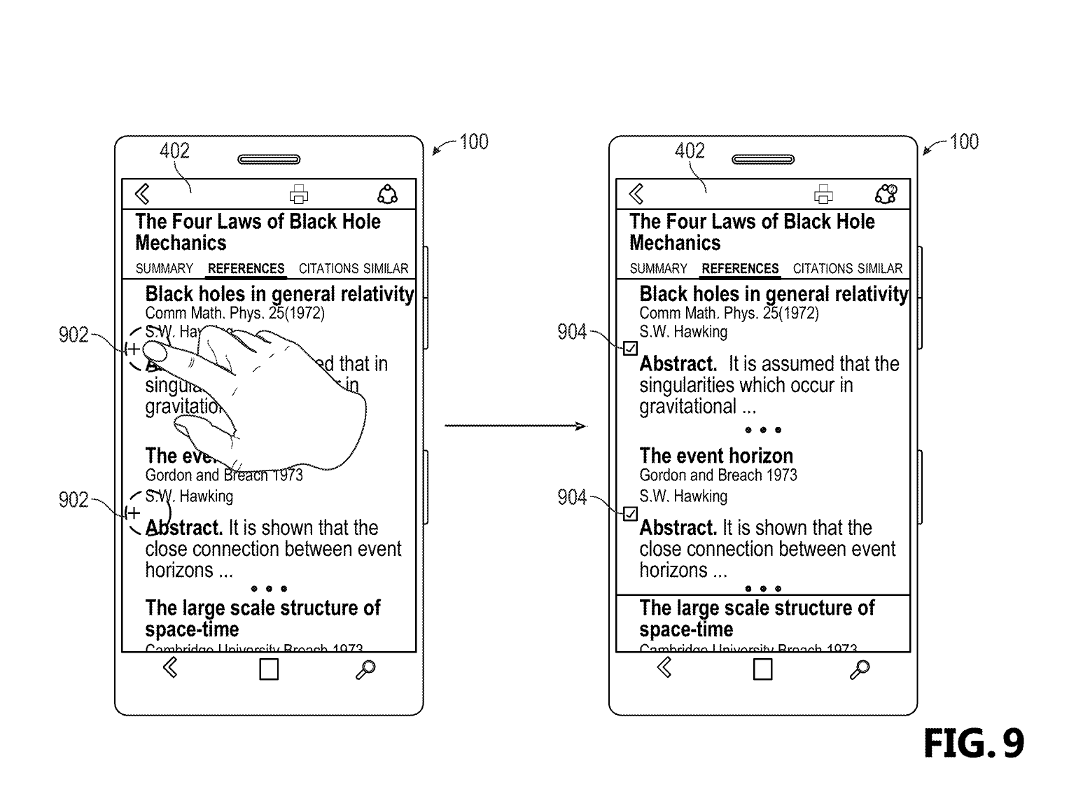

FIG. 9 is an illustration showing an interaction with an application user interface 402 for selecting 902 references in an example content item and source detection system 100 on a computing device. The illustrated example depicts the user's interaction with the application user interface 402. Specifically, the user has selected two relevant references that are of interest to the user. In response to this selection, the illustrated example is updated to provide a visual indication 904 of the selections. Further, the application user interface 402 displays a user interface element that identifies that two references have been selected to share or store.

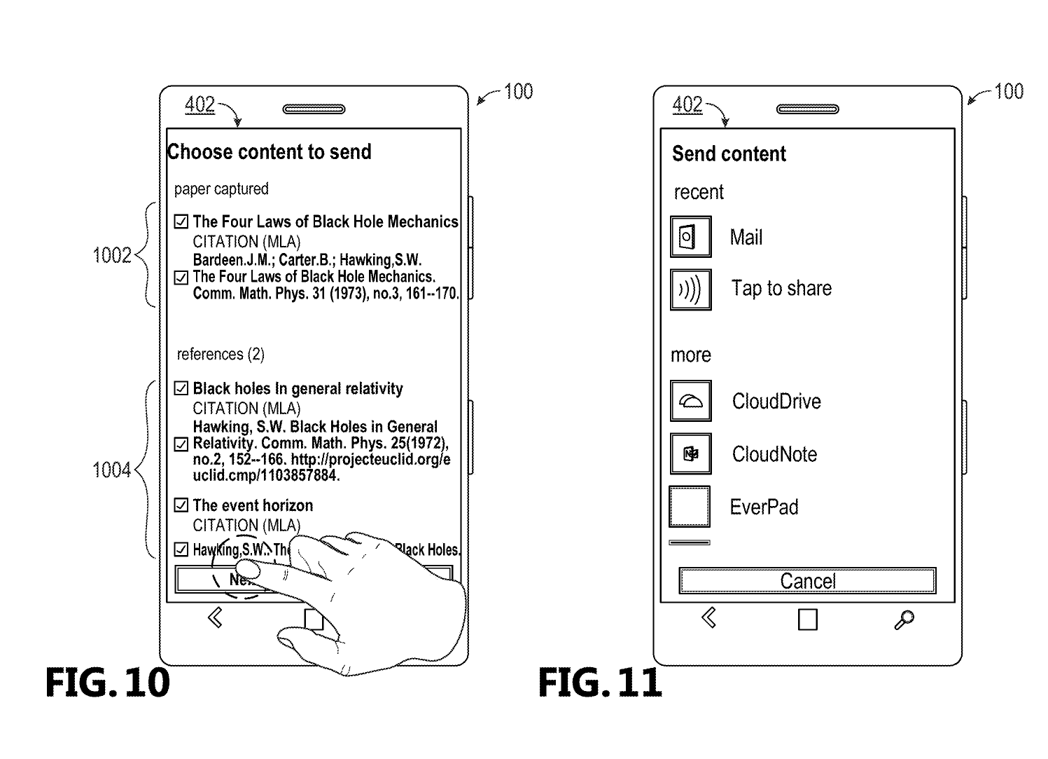

FIG. 10 is an illustration showing an interaction with an application user interface 402 for sharing and exporting content items in an example content item and source detection system 100 on a computing device. As illustrated, in response to receiving a selection of the user interface element to share or store, the application user interface 402 displays a listing of the content item 1002 and the two selected references 1004. The application user interface 402 may also include an option to cancel or request to proceed with storing or sharing the content item.

FIG. 11 is an illustration showing an application user interface 402 to provide options for sharing content items in an example content item and source detection system 100 on a computing device. Particularly, the example application user interface 402 illustrates various ways that the content items may be stored or shared. According to one aspect, the application user interface 402 may provide the sharing and export options in response to a user selecting to share a content item that is being viewed. According to another aspect, a user may select an option to share the content item before viewing the content item. In another example the options for sharing may be displayed with the content item. According to any of these aspects, the application user interface 402 may categorize the options based upon recent selections. Further, it should be recognized that the content items may be locally shared, emailed, or stored to a cloud-based service. In another example, the example content item and source detection system 100 creates a new document for recording the collection of additional content items provided in the search results. In another example, the content item and source detection system 100 opens an existing document and the additional content items are added to the document via a new page or a designated existing section within the document.

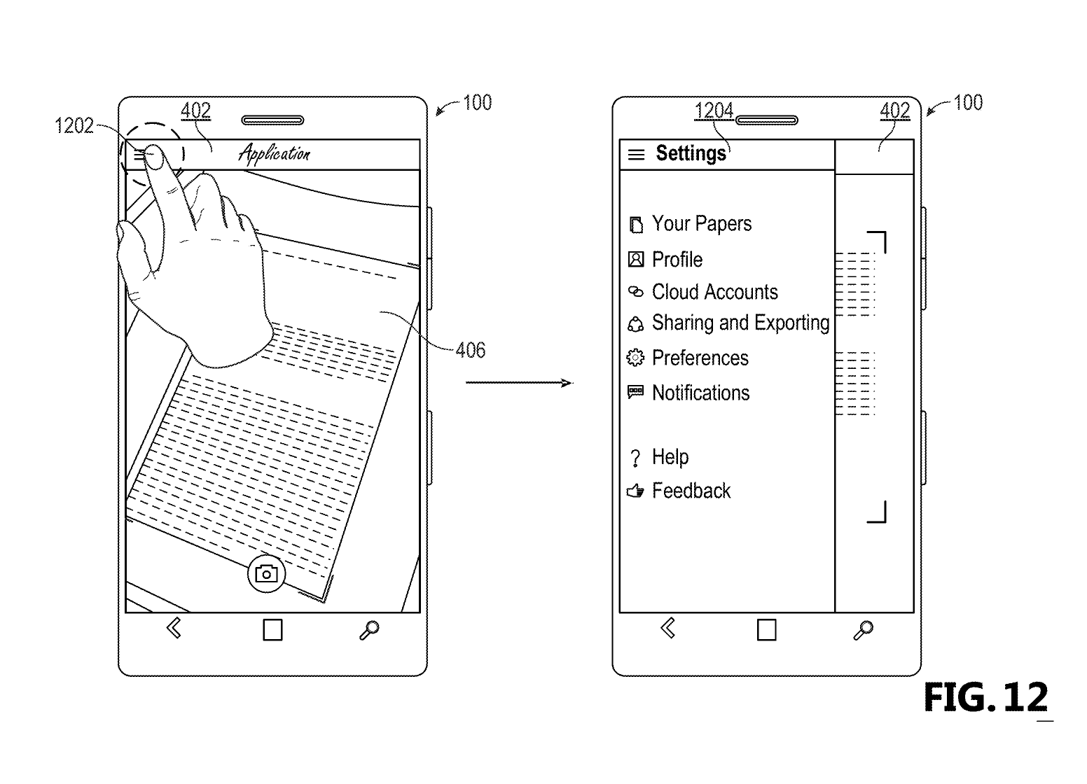

FIG. 12 is an illustration showing an interaction with an application user interface 402 for displaying account information in an example content item and source detection system 100 on a computing device. Specifically, in one example, the application user interface 402 depicts that the user has selected a settings user interface element 1202. In other examples, the application user interface 402 may include other options for selecting the settings. In response to the selection of settings user interface element 1202, the application user interface 402 is updated from displaying the image of the printed document 406 to display applicable settings 1204. For example, the settings may include an option to view papers that the user has locally saved, an option for user profile information, an option for account information for cloud-based services, an option for sharing and exporting content items, option for user preferences, an option for user notifications, and help and feedback functionalities.

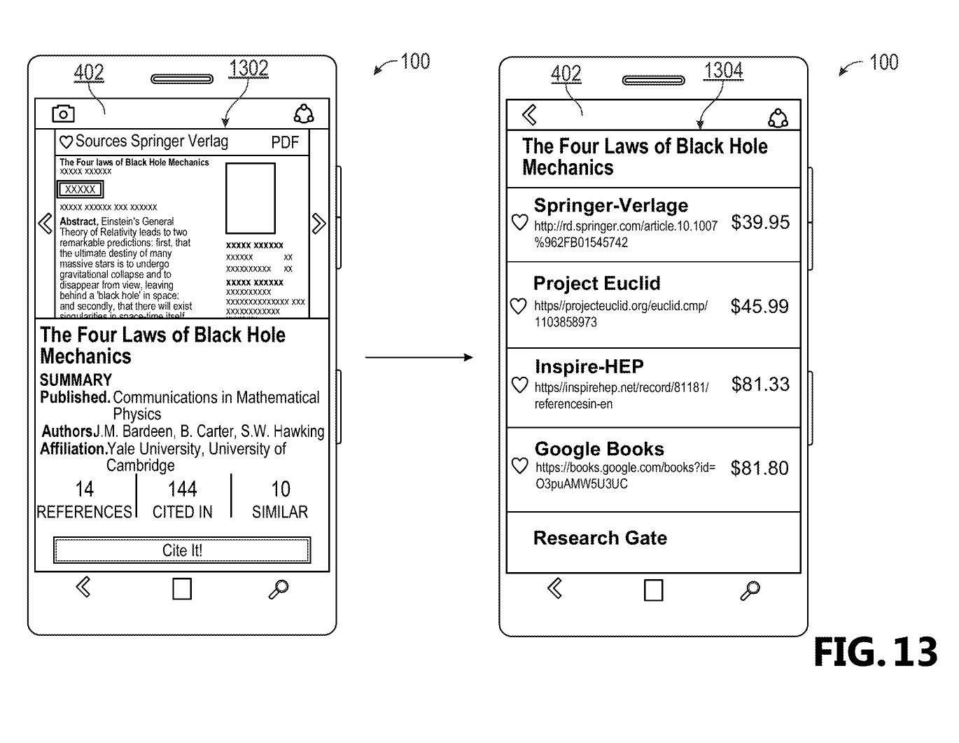

FIG. 13 is an illustration showing an interaction with an application user interface 402 for locating content items available for purchase in an example content item and source detection system 100 on a computing device. As should be appreciated, certain content items may not be freely available to the public. As illustrated, when a user captures an image of a content item that is not freely available, the content item and source detection system 100 may locate responsive content items that are available for purchase 1302. If the user selects to view more information about the purchasing options, the user interface may be updated to display seller and pricing information 1304 through which the user can purchase the content item. According to one or more aspects, a user may scroll though the purchasing options, modify the display of the purchasing options, and/or sort the purchasing options based on user input.

Alternatively, the user may already have access to the private source, for example via an existing account with the private source, and the application user interface 402 will prompt the user for login information or automatically use login information from a login information storage solution to provide the user with access to the content item held behind a paywall. Additionally, the application user interface 402 may prioritize the presentation of content items that are free to access (or the user already has paid access rights for) over content items for which the user has not paid for access rights.

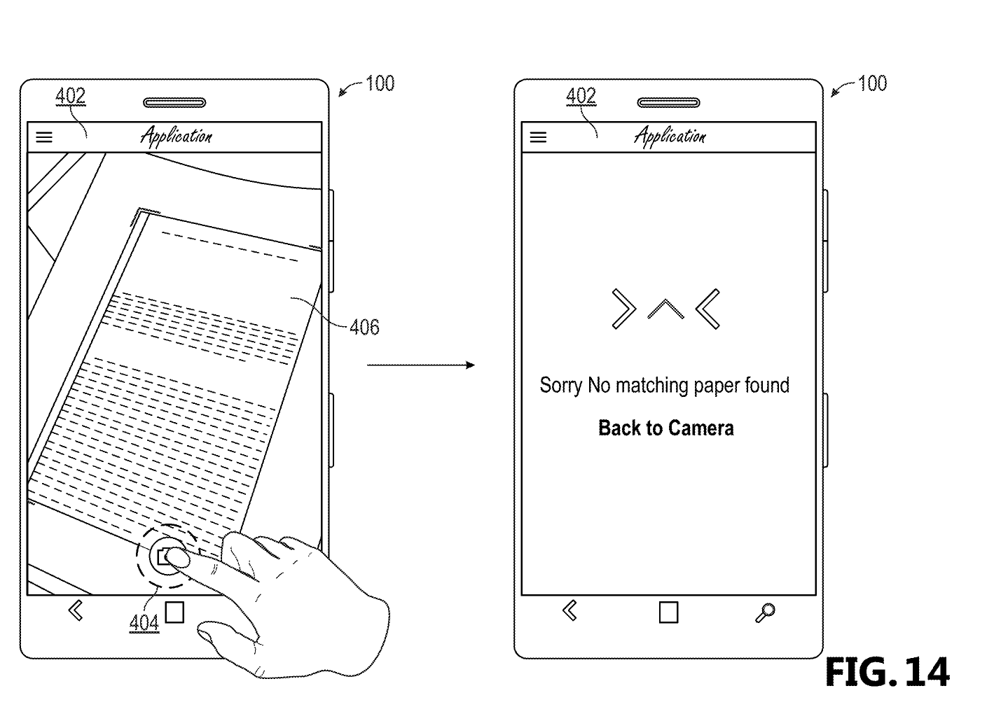

FIG. 14 is an illustration showing an interaction with an application user interface 402 in an example content item and source detection system 100 on a computing device. As illustrated, the content item and source detection system 100 may be unable to locate a content item corresponding to the image of a printed document 406 or other non-textual input provided. In such a situation, the application is unable to provide results. In the illustrated example, the application user interface 402 provides a notification that no matching content item could be found.

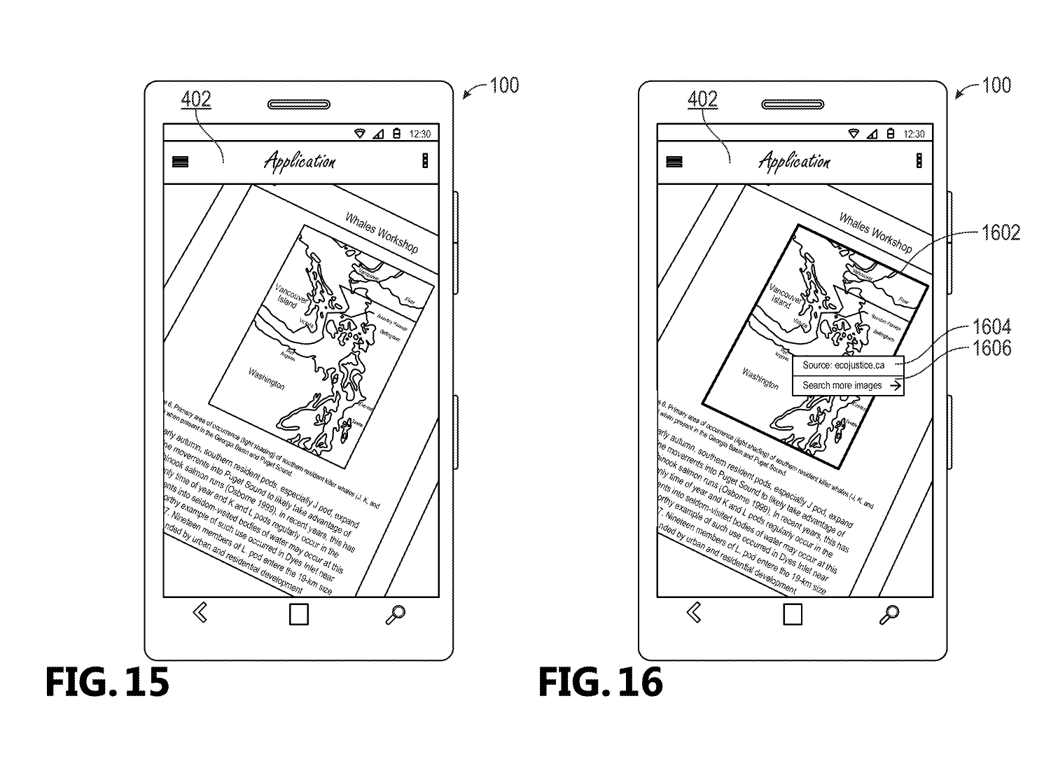

FIG. 15 is an illustration showing an application user interface 402 in an example content item and source detection system 100 on a computing device. It should also be recognized that the content item and source detection system 100 may be utilized to receive content from other types of media. For example, in the illustrated example, a mobile computing device is being utilized to obtain an image of a content item being displayed on a tablet. In other examples, a computing device may receive input from a presentation, a display device, speech, and other types of non-textual input.

FIG. 16 is an illustration showing an interaction with an application user interface 402 in an example content item and source detection system 100 on a computing device. In the illustrated example, the picture 1602 in the captured input is selected by a user. In response to this selection, the application user interface 402 displays selectable options for locating additional content items relating to the picture in the captured input. For example, the illustrated options include obtaining additional content items from the source 1604 of the image and an option to search other sources 1606 for additional content items. It should also be appreciated that the application user interface 402 may present other options for searching for related content.

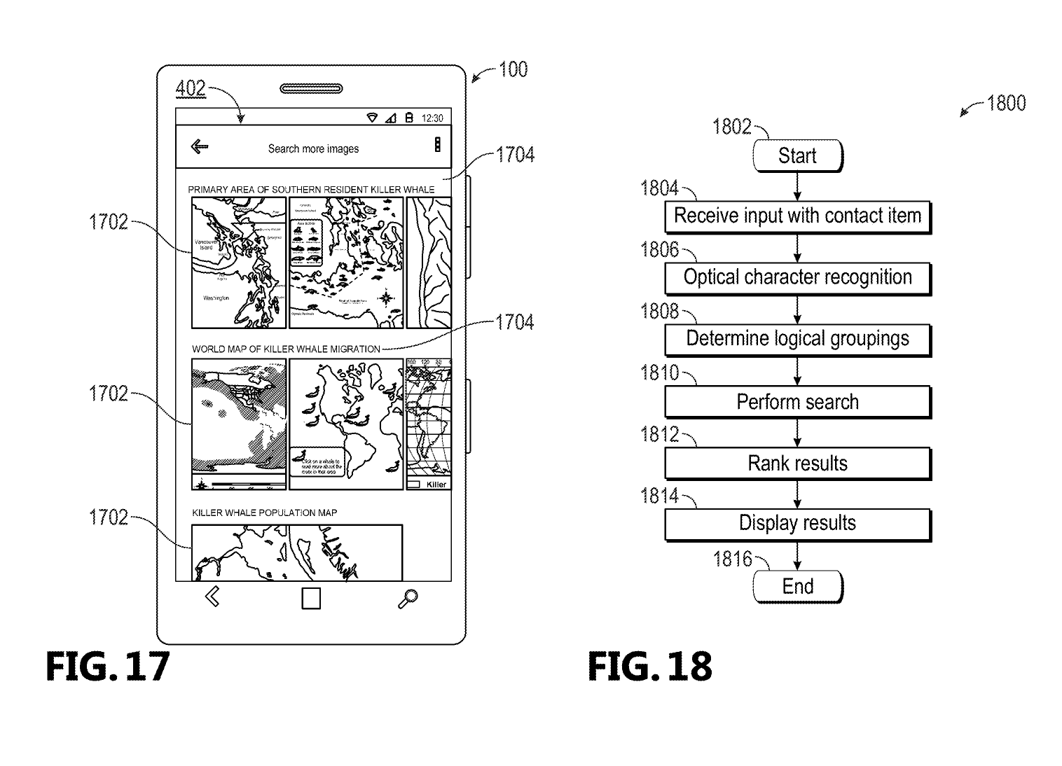

FIG. 17 is an illustration showing an application user interface 402 for displaying additional content items in an example content item and source detection system 100 on a computing device. In response to a selection to search for additional content items, the user interface is updated to display the content item and other relevant content items. This allows the user to utilize the example content item and source detection system 100 to locate one or more sources for a particular image. Specifically, the illustrated example displays other pictures 1702 that relate to the content items. The user interface may also display relevant textual information 1704 to provide additional information relating to the content items being displayed.

FIG. 18 is a flow chart showing general stages involved in an example method for detection of content items and source information. The method for detecting content items and source information begins at step 1802 and proceeds to 1804, where the content and source detection system 100 receives input relating to a content item. In one example, the content and source detection system 100 provides a user interface to allow a user to capture an image of a content item, e.g., a page of a printed document.

After the computing device has received the input associated with the content item, the method continues to 1806, where the input is analyzed to identify searchable data that relates to the input. For example, the captured image may be processed via optical character recognition to obtain textual data.

The method continues to 1808, where the textual data are grouped into logical groupings. For example, the textual data may organize the authors name into a logical grouping. In another example, the textual data may be parsed into text strings of relevant information. In other examples, the searchable data may be otherwise organized into other logical groupings. Logical groupings may be based on the formatting of a given text string (including its color, size, typeface, underline, boldface, strikethrough, and italic characteristics) being distinct from that of other text strings, a specified location of the text string in the image of the document 406, amount of whitespace until the next text string in the image of the document 406, textual or vocal cues identifying a logical grouping (e.g., the word “authors,” beginning the grouping or the phrase “et al” ending the grouping for a logical grouping identifying authors of a document).

The method continues to 1810, where the content and source detection system 100 performs a search for the content items that are responsive to the searchable data. Further at 1812, these content items may be ranked for presentation to the user based on a relevance of the content items to the search string, a reputation of the content source (e.g., promoting official sites over sites using keyword salting of robot text, original printers over republishers, university libraries over enthusiast or news sites), and a payment requirement for a content source (e.g., prioritizing freely accessible sites over sites with paywalls, prioritizing sites for which access rights have been paid for over other sites).

The method continues to 1814, where candidate results for the content items are displayed. In one example, the candidate results are displayed according to the relevance ranking associated with the candidate result. For example, the user interface may display the top five candidate results for the user to view. According to an aspect, the candidate results may include additional information related to the content items, including title, authors, abstract, citations, etc. The method ends at 1816.

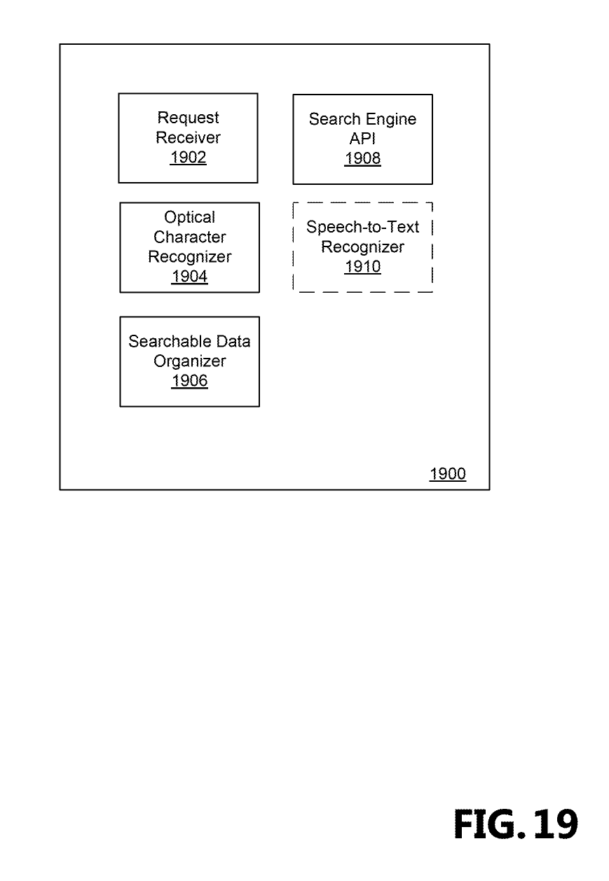

FIG. 19 is a block diagram of an example content item and source detection system 1900. As illustrated, the example system 1900 includes a request receiver 1902, an optical character recognizer 1904, a search string organizer 1906, and a search engine application program interface 1908. The example system 100 may also include a speech-to-text recognizer 1910.

The request receiver 1902 is operable to receive a non-textual request for a content item. For example, a spoken language voice request via microphone or an image of a printed document 406 via a camera or external source.

The optical character recognizer 1904 is operable to identify characters in the non-textual request for the content item when the non-textual request for the content item is an image of a portion of the content item requested.

The search string organizer 1906 is operable to prioritize a subset of the identified characters from the non-textual request for the content item as searchable data. For example, the search string organizer 1906 may identify one or more search strings from the non-textual request.

The search string organizer 1906 may also compare relative sizes of the identified characters and relative positions of the identified characters to prioritize the subset of the identified characters as the search string. For example, larger than average characters at the “top” of a document may be identified as a title for the document. In another example, characters that are part of a logical grouping or groupings below a logical grouping identified as a title may be identified as the authors of the document.

The search engine application program interface 1908 is operable to perform a search based on the searchable data. The search engine application program interface 1908 is configured to perform one or more types of searching. For example, the search engine application program interface 1908 may be configured to perform a search of an Internet resource (e.g., a search engine), a private database, the user's personal computing device, storage drives, or any other resource relevant to the content item. In one example, the search engine application program interface 1908 may be operable to perform an Internet search query for an identified search string. According to one aspect, the search engine application program interface 1908 prioritizes results of the Internet search based on an relevance of the results to the search string, and availability of a source to the user, including whether the source is freely available to the user, whether the user has already paid for access to the source, and whether the source includes free previews of the requested content. According to another aspect, the search engine application program interface 1908 prioritizes the results based on a reliability of the source, including whether the source is an original source, whether the source is a trusted source, whether the source is a requested source, and whether the source is a for-profit source.

The speech-to-text recognizer 1910 is operable to identify words in the non-textual request for the content item when the non-textual request for the content item is a voice request for the content item.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

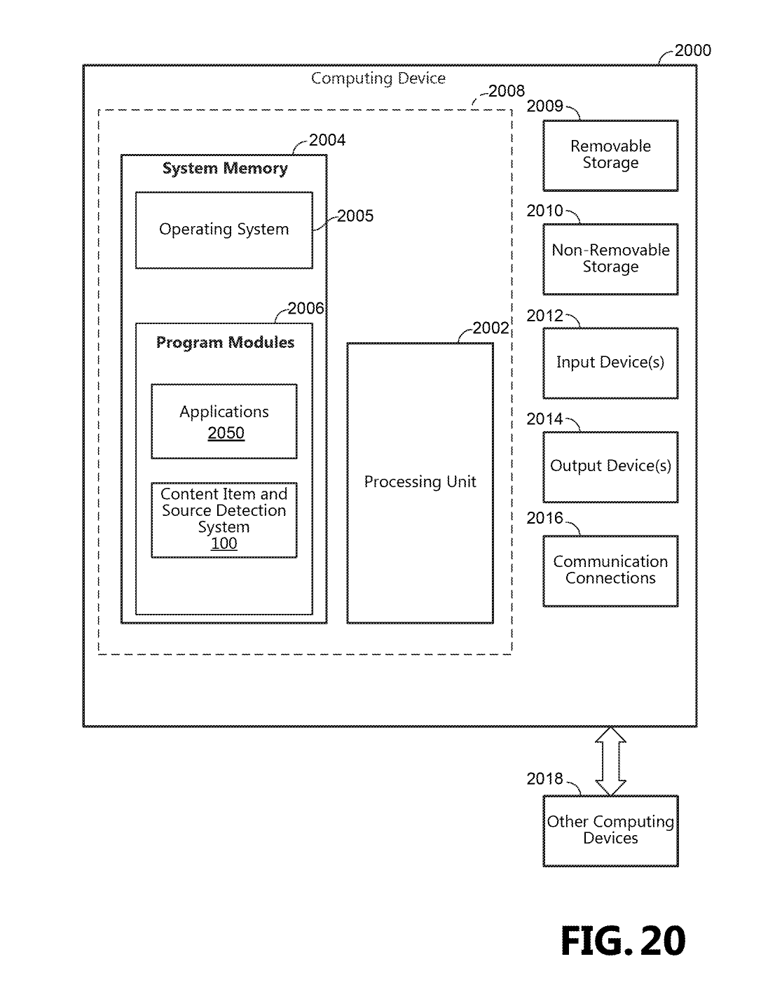

FIGS. 20-22 and the associated descriptions provide a discussion of a variety of operating environments in which examples are practiced. However, the devices and systems illustrated and discussed with respect to FIGS. 20-22 are for purposes of example and illustration and are not limiting of a vast number of computing device configurations that are utilized for practicing aspects, described herein.

FIG. 20 is a block diagram illustrating physical components (i.e., hardware) of a computing device 2000 with which examples of the present disclosure may be practiced. In a basic configuration, the computing device 2000 includes at least one processing unit 2002 and a system memory 2004. According to an aspect, depending on the configuration and type of computing device, the system memory 2004 comprises, but is not limited to, volatile storage (e.g., random access memory), non-volatile storage (e.g., read-only memory), flash memory, or any combination of such memories. According to an aspect, the system memory 2004 includes an operating system 2005 and one or more program modules 2006 suitable for running software applications 2050. According to an aspect, the system memory 2004 includes content item and source detection system 100. The operating system 2005, for example, is suitable for controlling the operation of the computing device 2000. Furthermore, aspects are practiced in conjunction with a graphics library, other operating systems, or any other application program, and is not limited to any particular application or system. This basic configuration is illustrated in FIG. 20 by those components within a dashed line 2008. According to an aspect, the computing device 2000 has additional features or functionality. For example, according to an aspect, the computing device 2000 includes additional data storage devices (removable and/or non-removable) such as, for example, magnetic disks, optical disks, or tape. Such additional storage is illustrated in FIG. 20 by a removable storage device 2009 and a non-removable storage device 2010.

As stated above, according to an aspect, a number of program modules and data files are stored in the system memory 2004. While executing on the processing unit 2002, the program modules 2006 (e.g., content item and source detection system 100) perform processes including, but not limited to, one or more of the stages of the method 1800 illustrated in FIG. 18. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit utilizing a microprocessor, or on a single chip containing electronic elements or microprocessors. For example, aspects are practiced via a system-on-a-chip (SOC) where each or many of the components illustrated in FIG. 20 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 2000 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 2000 has one or more input device(s) 2012 such as a keyboard, a mouse, a pen, a sound input device, a touch input device, etc. The output device(s) 2014 such as a display, speakers, a printer, etc. are also included according to an aspect. The aforementioned devices are examples and others may be used. According to an aspect, the computing device 2000 includes one or more communication connections 2016 allowing communications with other computing devices 2018. Examples of suitable communication connections 2016 include, but are not limited to, radio frequency (RF) transmitter, receiver, and/or transceiver circuitry; universal serial bus (USB), parallel, and/or serial ports.

The term computer readable media, as used herein, includes computer storage media. Computer storage media include volatile and nonvolatile, removable and non-removable media implemented in any method or technology for storage of information, such as computer readable instructions, data structures, or program modules. The system memory 2004, the removable storage device 2009, and the non-removable storage device 2010 are all computer storage media examples (i.e., memory storage.) According to an aspect, computer storage media include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 2000. According to an aspect, any such computer storage media is part of the computing device 2000. Computer storage media do not include a carrier wave or other propagated data signal.

According to an aspect, communication media are embodied by computer readable instructions, data structures, program modules, or other data in a modulated data signal, such as a carrier wave or other transport mechanism, and include any information delivery media. According to an aspect, the term “modulated data signal” describes a signal that has one or more characteristics set or changed in such a manner as to encode information in the signal. By way of example, and not limitation, communication media include wired media such as a wired network or direct-wired connection, and wireless media such as acoustic, radio frequency (RF), infrared, and other wireless media.

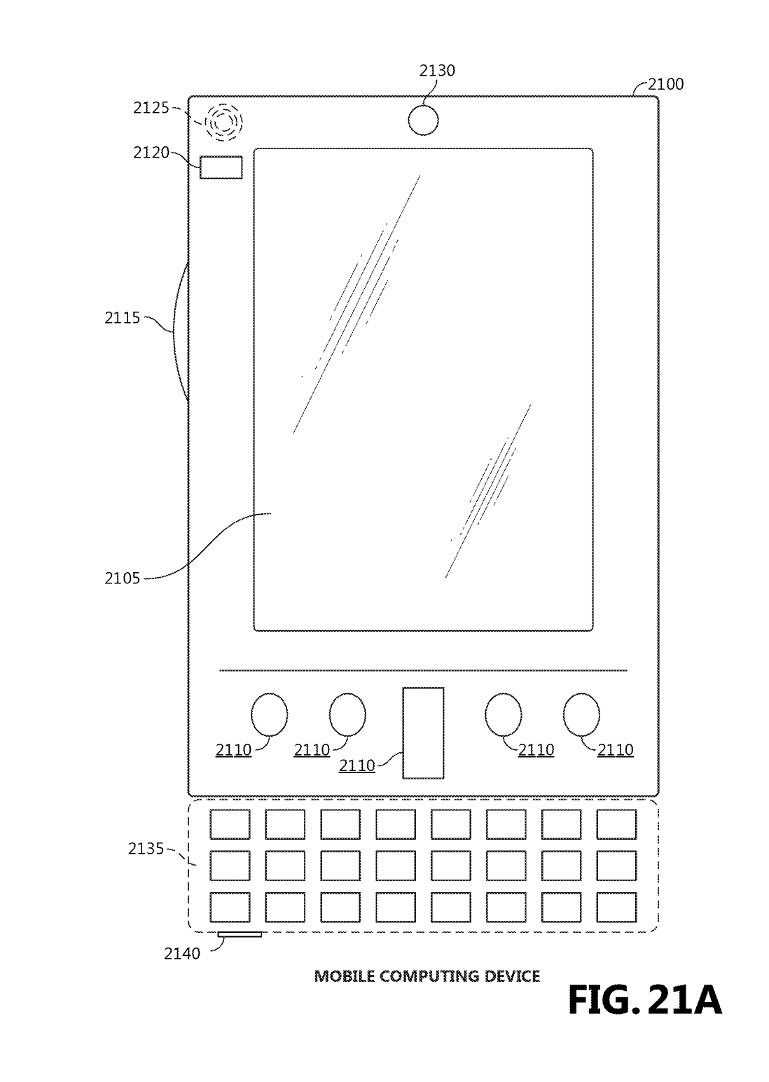

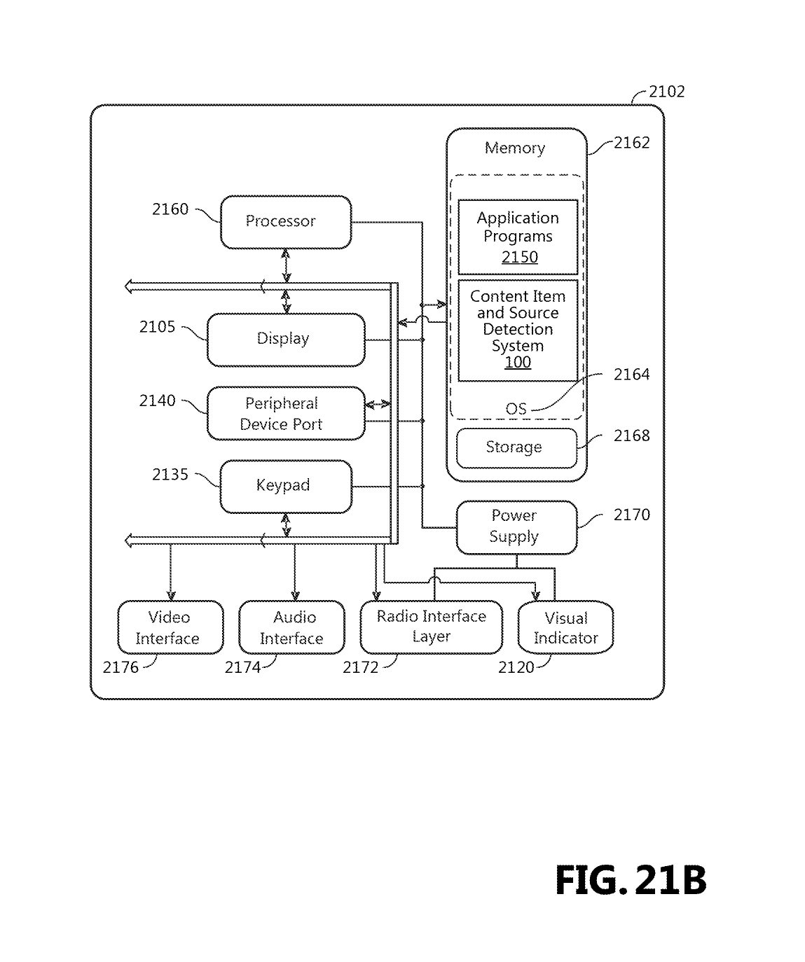

FIGS. 21A and 21B illustrate a mobile computing device 2100, for example, a mobile telephone, a smart phone, a tablet personal computer, a laptop computer, and the like, with which aspects may be practiced. With reference to FIG. 21A, an example of a mobile computing device 2100 for implementing the aspects is illustrated. In a basic configuration, the mobile computing device 2100 is a handheld computer having both input elements and output elements. The mobile computing device 2100 typically includes a display 2105 and one or more input buttons 2110 that allow the user to enter information into the mobile computing device 2100. According to an aspect, the display 2105 of the mobile computing device 2100 functions as an input device (e.g., a touch screen display). If included, an optional side input element 2115 allows further user input. According to an aspect, the side input element 2115 is a rotary switch, a button, or any other type of manual input element. In alternative examples, mobile computing device 2100 incorporates more or fewer input elements. For example, the display 2105 may not be a touch screen in some examples. In alternative examples, the mobile computing device 2100 is a portable phone system, such as a cellular phone. According to an aspect, the mobile computing device 2100 includes an optional keypad 2135. According to an aspect, the optional keypad 2135 is a physical keypad. According to another aspect, the optional keypad 2135 is a “soft” keypad generated on the touch screen display. In various aspects, the output elements include the display 2105 for showing a graphical user interface (GUI), a visual indicator 2120 (e.g., a light emitting diode), and/or an audio transducer 2125 (e.g., a speaker). In some examples, the mobile computing device 2100 incorporates a vibration transducer for providing the user with tactile feedback. In yet another example, the mobile computing device 2100 incorporates a peripheral device port 2140, such as an audio input (e.g., a microphone jack), an audio output (e.g., a headphone jack), and a video output (e.g., a HDMI port) for sending signals to or receiving signals from an external device.

FIG. 21B is a block diagram illustrating the architecture of one example of a mobile computing device. That is, the mobile computing device 2100 incorporates a system (i.e., an architecture) 2102 to implement some examples. In one example, the system 2102 is implemented as a “smart phone” capable of running one or more applications (e.g., browser, e-mail, calendaring, contact managers, messaging clients, games, and media clients/players). In some examples, the system 2102 is integrated as a computing device, such as an integrated personal digital assistant (PDA) and wireless phone.

According to an aspect, one or more application programs 2150 are loaded into the memory 2162 and run on or in association with the operating system 2164. Examples of the application programs include phone dialer programs, e-mail programs, personal information management (PIM) programs, word processing programs, spreadsheet programs, Internet browser programs, messaging programs, and so forth. According to an aspect, the content item and source detection system 100 is loaded into memory 2162. The system 2102 also includes a non-volatile storage area 2168 within the memory 2162. The non-volatile storage area 2168 is used to store persistent information that should not be lost if the system 2102 is powered down. The application programs 2150 may use and store information in the non-volatile storage area 2168, such as e-mail or other messages used by an e-mail application, and the like. A synchronization application (not shown) also resides on the system 2102 and is programmed to interact with a corresponding synchronization application resident on a host computer to keep the information stored in the non-volatile storage area 2168 synchronized with corresponding information stored at the host computer. As should be appreciated, other applications may be loaded into the memory 2162 and run on the mobile computing device 2100.

According to an aspect, the system 2102 has a power supply 2170, which is implemented as one or more batteries. According to an aspect, the power supply 2170 further includes an external power source, such as an AC adapter or a powered docking cradle that supplements or recharges the batteries.

According to an aspect, the system 2102 includes a radio 2172 that performs the function of transmitting and receiving radio frequency communications. The radio 2172 facilitates wireless connectivity between the system 2102 and the “outside world,” via a communications carrier or service provider. Transmissions to and from the radio 2172 are conducted under control of the operating system 2164. In other words, communications received by the radio 2172 may be disseminated to the application programs 2150 via the operating system 2164, and vice versa.

According to an aspect, the visual indicator 2120 is used to provide visual notifications and/or an audio interface 2174 is used for producing audible notifications via the audio transducer 2125. In the illustrated example, the visual indicator 2120 is a light emitting diode (LED) and the audio transducer 2125 is a speaker. These devices may be directly coupled to the power supply 2170 so that when activated, they remain on for a duration dictated by the notification mechanism even though the processor 2160 and other components might shut down for conserving battery power. The LED may be programmed to remain on indefinitely until the user takes action to indicate the powered-on status of the device. The audio interface 2174 is used to provide audible signals to and receive audible signals from the user. For example, in addition to being coupled to the audio transducer 2125, the audio interface 2174 may also be coupled to a microphone to receive audible input, such as to facilitate a telephone conversation. According to an aspect, the system 2102 further includes a video interface 2176 that enables an operation of an on-board camera 2130 to record still images, video stream, and the like.

According to an aspect, a mobile computing device 2100 implementing the system 2102 has additional features or functionality. For example, the mobile computing device 2100 includes additional data storage devices (removable and/or non-removable) such as, magnetic disks, optical disks, or tape. Such additional storage is illustrated in FIG. 21B by the non-volatile storage area 2168.

According to an aspect, data/information generated or captured by the mobile computing device 2100 and stored via the system 2102 are stored locally on the mobile computing device 2100, as described above. According to another aspect, the data are stored on any number of storage media that are accessible by the device via the radio 2172 or via a wired connection between the mobile computing device 2100 and a separate computing device associated with the mobile computing device 2100, for example, a server computer in a distributed computing network, such as the Internet. As should be appreciated, such data/information are accessible via the mobile computing device 2100 via the radio 2172 or via a distributed computing network. Similarly, according to an aspect, such data/information are readily transferred between computing devices for storage and use according to well-known data/information transfer and storage means, including electronic mail and collaborative data/information sharing systems.

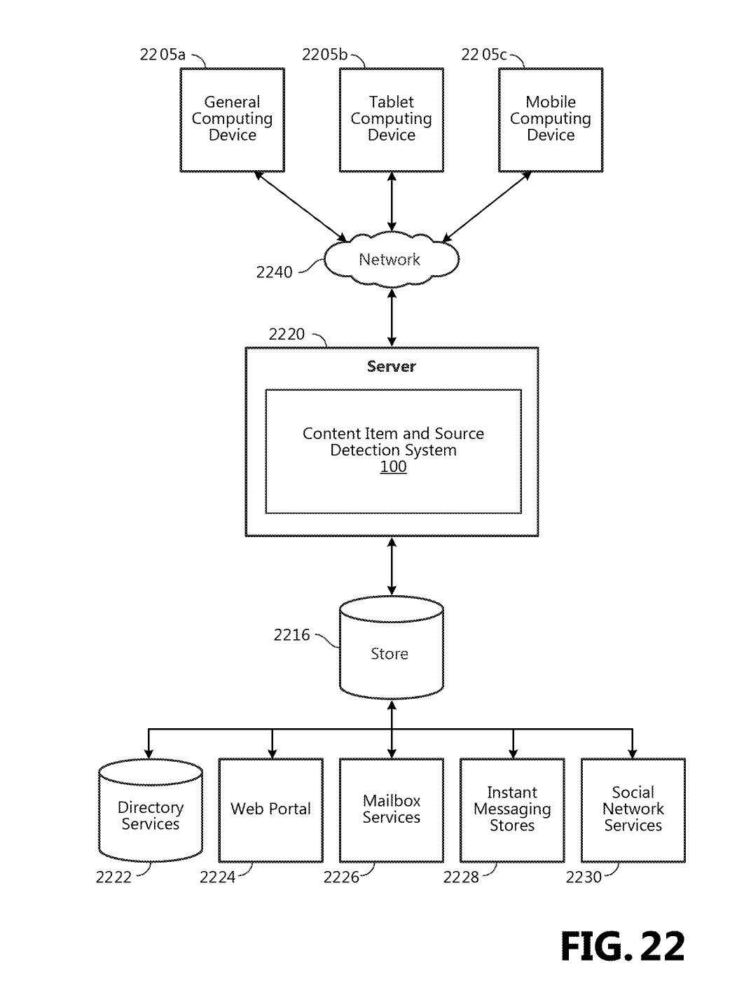

FIG. 22 illustrates one example of the architecture of a system for detection of content items and source information as described above. Content developed, interacted with, or edited in association with the content item and source detection system 100 is enabled to be stored in different communication channels or other storage types. For example, various documents may be stored using a directory service 2222, a web portal 2224, a mailbox service 2226, an instant messaging store 2228, or a social networking site 2230. The content item and source detection system 100 is operative to use any of these types of systems or the like for reducing latency of document change discovery in a co-authoring session, as described herein. According to an aspect, a server 2220 provides the content item and source detection system 100 to clients 2205a,b,c. As one example, the server 2220 is a web server providing the content item and source detection system 100 over the web. The server 2220 provides the content item and source detection system 100 over the web to clients 2205 through a network 2240. By way of example, the client computing device is implemented and embodied in a personal computer 2205a, a tablet computing device 2205b or a mobile computing device 2205c (e.g., a smart phone), or other computing device. Any of these examples of the client computing device are operable to obtain content from the store 2216.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope of the present disclosure.

We claim:

1. A method for improving efficiency in a computer device locating content items accessible to a user, comprising:
receiving non-textual input;
analyzing the non-textual input to identify searchable data;
performing a search for the content items that are responsive to the searchable data;
ranking the content items based on relevance to the searchable data; and
displaying the results of the search including at least a portion of the content items.

2. The method of claim 1, further comprising grouping the searchable data into logical groupings.

3. The method of claim 2, wherein the logical groupings include text strings.

4. The method of claim 1, wherein the receiving non-textual input includes receiving an image of a printed document.

5. The method of claim 1, wherein analyzing the non-textual input to identify searchable data includes processing the non-textual input via optical character recognition to obtain textual data.

6. The method of claim 1, wherein ranking the content items based on relevance to the searchable data is based at least in part on a reputation of the content source.

7. The method of claim 1, wherein ranking the content items based on relevance to the searchable data is based at least in part on whether the content items requires a payment for access.

8. The method of claim 1, wherein results are displayed according to the ranking associated with the content items relevance to the searchable data.

9. A system for improving efficiency in a computer device locating content items accessible to a user, comprising:
a processor; and
a memory, including instructions, which when executed by the processor are operable to provide:
a request receiver, operable to receive a non-textual request for a content item;
an optical character recognizer, operable to identify characters in the non-textual request for the content item when the non-textual request for the content item is an image of a portion of the content item requested;
a search string organizer, operable to prioritize a subset of the identified characters from the non-textual request for the content item as a search string, wherein the search string organizer compares relative sizes of the identified characters and relative positions of the identified characters to prioritize the subset of the identified characters as the search string;
a search engine application program interface, operable to perform an search based on the search string, wherein the search engine application program interface is operable to prioritize results of the Internet search based on an relevance of the results to the search string, and availability of a source to the user, including whether the source is freely available to the user, whether the user has already paid for access to the source, and whether the source includes free previews of the requested content item.

10. The system of claim 9, wherein the instructions further provide:
a speech-to-text recognizer, operable to identify words in the non-textual request for the content item when the non-textual request for the content item is a voice request for the content item.

11. The system of claim 9, wherein the search engine application program interface is further operable to prioritize the results based on a reliability of the source, including whether the source is an original source, whether the source is a trusted source, whether the source is a requested source, and whether the source is a for-profit source.

12. The system of claim 9, wherein the search string organizer is further operable to group the identified characters into logical groupings.

13. The system of claim 9, wherein the search engine application program interface is further operable to rank the content items based on a relevance to the searchable data based at least in part on a reputation of the content source.

14. The system of claim 13, wherein the search engine application program interface is further operable to rank the content items based on the relevance to the searchable data based at least in part on whether the content items require a payment for access.

15. The system of claim 13, wherein the search engine application program interface is further operable to display results according to the ranking associated with the content items relevance.

16. A computer readable storage device including instructions, which when executed by a processor are operable to perform the steps comprising:
receiving non-textual input including an image of a printed document;
analyzing the non-textual input to identify searchable data;
grouping the searchable data into logical groupings;
performing a search for the content items that are responsive to the searchable data;
ranking the content items based on relevance to the searchable data; and
displaying the results of the search including at least a portion of the content items.

17. The computer readable storage device of claim 16, wherein analyzing the non-textual input to identify searchable data includes processing the non-textual input via optical character recognition to obtain textual data.

18. The method of claim 16, wherein ranking the content items based on relevance to the searchable data is based at least in part on a reputation of the content source.

19. The method of claim 16, wherein ranking the content items based on relevance to the searchable data is based at least in part on whether the content items requires a payment for access.

20. The method of claim 16, wherein results are displayed according to the ranking associated with the content items relevance to the searchable data.
